(19) United States
(12) Patent Application Publication
(10) Pub. No.: US 2014/0234116 A1
(43) Pub. Date: Aug. 21, 2014

(54) DEVICE FOR CONNECTING WING SECTIONS AND METHOD FOR ASSEMBLING SUCH SECTIONS

(71) Applicant: ASTRIUM SAS, Paris (FR)

(72) Inventors: David Cussac, Saint Medard En Jalles (FR); Antoine Humblot, Saint Medard En Jalles (FR)

(21) Appl. No.: 14/345,890

(22) PCT Filed: Sep. 18, 2012
(86) PCT No.: PCT/EP2012/068285

§ 371 Date: Mar. 19, 2014

(30) Foreign Application Priority Data
Sep. 20, 2011 (FR) 1158357

(51) Int. Cl. F03D 1/06; F03D 1/00

(52) U.S. Cl. CPC F03D 1/0675; F03D 1/001
USPC 416/226; 29/889.71

(57) ABSTRACT

A device for connecting sections of wings such as wind turbine blades, which has, at the ends of adjacent sections, central box structures that are placed end-to-end and are clamped together by clamping rods, and a method for producing sections of wings such as wind turbine blades, which includes a step of producing devices for connecting the sections in the form of central joining box structures

### CROSS-REFERENCE TO RELATED APPLICATIONS

This application is the National Stage of International Application No. PCT/EP2012/068285 having International filing date, 18 Sep. 2012, which designated the United States of America, and which International Application was published under PCT Article 21 (s) as WO Publication 2013/041498 A1 and which claims priority from, and benefit of, French Application No. 1158357 filed on 20 Sep. 2011, the disclosures of which are incorporated herein by reference in their entireties.

### BACKGROUND

The presently disclosed embodiment relates to the technology of mechanical connections of structural parts made of composite materials and the devices for assembling such parts and in particular sections of wings or of blades. One particular application of the presently disclosed embodiment is that of wind turbine blades.

Wind turbines in which the blades reach lengths of up to several tens of meters are being designed nowadays. Such blades obviously present numerous technical, but also logistical problems. Terrestrial or maritime transport of these structures can prove to be problematic, especially if it is difficult to access the installation area. From a technical point of view, the use of composite materials makes it possible to lighten the blades and thus to reduce the forces on the entire structure of the wind turbine (blades/mast/foundations). From a logistical point of view, assembling the blade sections on site makes it possible to reduce the criticality and the costs of the transport phases.

The problem thus arises of assembling parts made of composite materials, with a view to providing a solution that is mechanically optimized in terms of mass, cost and simplicity.

It will be seen that there are two large families of connecting methods:
adhesive-bonding methods, which can optionally include fibers or fabrics, the technology of which thus comes close to that of the production of composite materials; the major drawback of adhesively bonded connections lies in the fact that they cannot be taken apart.
mechanical methods, which make it possible to take apart the connections. These mechanical methods can be found for example in the documents EP 1 584 817, EP 1 878 915 and EP 1 244 873.

In all cases, the connection is made by metallic parts which are themselves fixed to the structure of the composite blade.

One of the features common to the documents EP 1 584 817, EP 1 878 915 and EP 1 244 873 is that the connection is brought about by a number of metallic parts, each being fixed to the composite in a discontinuous manner by mechanical fasteners (screws, pins).

However, these solutions do not ensure that a uniform force is passed over the entire composite wall, and this generates local excess forces, resulting in a lack of optimization of the structure.

In this case, a risk of progressive failure, starting in the areas under the highest stress, a peeling phenomenon, can exist.

In addition, in terms of mechanical analysis, these local excess forces are difficult to measure, and this has an adverse effect on the reliability and optimization of the structure. Thus, the connection produced is difficult to ensure.

It should also be noted that EP 1 878 915 describes a connection which relates to the skin of the blade as a whole, whereas in advanced designs, the blade has a central box structure which bears the efforts and on which the connections are located.

The document FR 2 948 154 in the name of the applicant relates to the assembly of sections of wind turbine blades and provides a pinned connection with at least double shear, the connection between the metal and the composite using one continuous fitting per side or a continuous and closed frame, to ensure that forces pass into the structure of the spar of the blade, the entirety of the connection, including the fastening elements, being located in the interior of the aerodynamic profile of the blade.

This removable connection is an adaptation of the mechanical connections originating in the field of aerospace. It involves complex and thus expensive metal frames. This type of connection is particularly suitable for blades having very large dimensions, for which the stresses are very high. This solution involves piercing the flange of the blade, and thus reinforcing it with additional plies. The double shear connection also involves a misalignment of the neutral axis of the flange necessary for ensuring the continuity of the aerodynamic profile. A cap thus has to be provided to cover this connection zone.

### SUMMARY

With respect to the prior art, the objectives of the presently disclosed embodiment are to produce a connection having an optimized cost and mass, by adhesive bonding and mechanical assembly, without piercing nor misalignment of the flange, which is removable, with a simplified on-site assembly method that ensures the continuity of the aerodynamic profile without the addition of a cap.

To this end, the solution proposed by the presently disclosed embodiment is based on the following principles: the sections of the blade are assembled via composite box structures that are adhesively bonded between the skins of each of the sections and an array of tie rods, the clamping of these tie rods to metal ribs optionally via hatches in the skins placing the box structures under compression. The box structures are similar to spacers.

More specifically, the presently disclosed embodiment proposes a device for connecting sections of wings such as wind turbine blades, which has, at the ends of adjacent sections, central box structures that are placed end-to-end and are clamped together by clamping rods.

The clamping forces subject the clamping rods to tensile forces and the box structures to compressive forces. Bending forces pass through the connections adhesively bonded between the box structures and the skins. Shear forces pass through the spars of the box structures.

Advantageously, each of the box structures is provided with a tubular connecting box and bearing plates, between which the connecting box is received.

Preferably, the clamping rods pass through the connecting boxes, the bearing plates being provided with through-holes for the clamping rods.

Advantageously, the rods form an array of tie rods, the clamping of these tie rods to the bearing plates placing the connecting boxes under compression.

According to one particular aspect of the disclosed embodiment, the bearing plates are shaped as ribs of the wing sections.

Advantageously, the box structures form spacers of the sections.

According to one particular aspect of the disclosed embodiment, the tubular connecting boxes have spars and cross-beams that are all adhesively bonded to closing blocks of the connecting boxes, said blocks forming, together with rigid external plates, said bearing plates.

According to one particular aspect of the disclosed embodiment, the spars are low-mass composite spars.

The cross-beams of the box structures are preferably flange elements of the sections.

The aspects of the disclosed embodiment also relate to a wing, such as a wind turbine blade, made of a number of sections, which has at least one connecting device according to the disclosed embodiment.

With the device being such that the cross-beams of the box structures are flange elements of the sections, the skins of the lower surface and upper surface of the sections of the wing are advantageously adhesively bonded to the flanges of the sections.

The wing may advantageously be such that the sections have at least one I-beam extending the box structures of the connecting device.

The aspects of the disclosed embodiment also relate to a method for producing sections of wings such as wind turbine blades, which comprises a step of producing devices for connecting said sections in the form of central joining box structures.

Preferably, each of the box structures is manufactured from a tubular connecting box and bearing plates, between which the tubular connecting box is received.

The method preferably comprises a step of drilling through-holes for clamping rods in the bearing plates and a step of positioning tubes for receiving the clamping rods between the bearing plates.

The method advantageously comprises a step of adhesively bonding spars of the connecting boxes to closing blocks of the boxes and of adhesively bonding cross-beams that form flanges of the box structures.

According to one particular aspect of the disclosed embodiment, the method comprises a step of placing the connecting devices end-to-end, the first bearing plates being pressed against a central packing piece, a step of inserting the rods and of putting the box structures under compression by way of clamping means at the ends of the rods.

Advantageously, the bearing plates are produced by assembling rigid external plates with the closing blocks of the boxes.

The method advantageously comprises a step of adhesively bonding a first skin, forming a first of the lower surface or upper surface of the section of the wing, to the connecting device and of adhesively bonding the first skin to a first flange assembled with a spar of a beam, and a step of adhesively bonding a second skin, forming the second of the lower surface or upper surface of the section of the wing, to the connecting device, to the first skin and to a second flange adhesively bonded to the spar, the first and second flanges and the spar forming a beam element of the wing.

Advantageously, the method then comprises a step of polymerizing the wing in a mold.

Preferably, the method comprises a final step of removing the rods and separating the sections by cutting the packing piece between the first bearing plates in order to store and transport the separated sections.

Finally, the aspects of the disclosed embodiment relate to a method for assembling wing sections produced by the method for producing sections according to the disclosed embodiment, said method comprising a step of placing the sections end-to-end in the region of the connecting devices, inserting clamping rods into the bearing plates of the connecting devices and clamping the rods by way of nuts at the ends of the rods.

### BRIEF DESCRIPTION OF THE DRAWINGS

Further features and advantages of the aspects of the disclosed embodiment will become apparent from reading the following description of a nonlimiting exemplary aspect of the disclosed embodiment with reference to the drawings, in which:

FIG. 1: shows a perspective overall view with an exploded view of a wing portion having the device according to the disclosed embodiment;

FIGS. 2A and 2B: show perspective views of first steps in the production of a box structure according to the disclosed embodiment;

FIG. 3: shows a perspective view of a second step in the production of a box structure according to the disclosed embodiment;

FIG. 4: shows a perspective view of box structures of two assembled sections;

FIGS. 5A and 5B: show two detail views of access holes providing access to the clamping rods for box structures according to the disclosed embodiment;

FIGS. 6A to 6D: show perspective views of external plates of box structures from FIG. 4;

FIG. 7: shows a perspective view of an exemplary aspect of the disclosed embodiment of a closing block according to one aspect of the disclosed embodiment.

### DETAILED DESCRIPTION

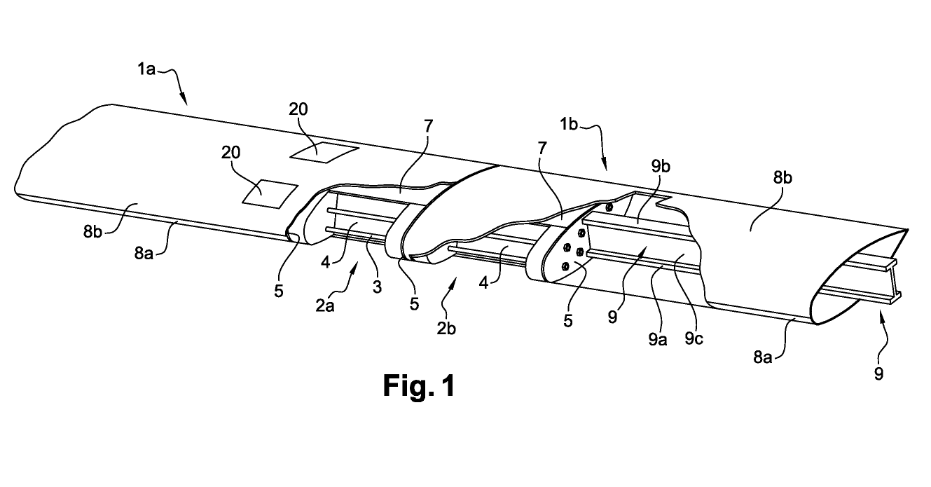

FIG. 1 shows a wing portion having two sections produced in accordance with the disclosed embodiment.

The wing, in this case a wind turbine blade, has a device for connecting the sections 1a, 1b, which has, at the ends of adjacent sections, central joining box structures 2a, 2b that are placed end-to-end and are clamped together by clamping rods 3, each of the box structures being provided with a tubular connecting box 4 and bearing plates 5, between which the connecting box 4 is received.

The sections have skins 8a, 8b forming the lower surface and upper surface of the wing, and hatches 20 for access to the clamping rods of the box structures.

The box structures 2a, 2b form spacers for the sections, which each have a beam 9 formed by a spar 9c and two flanges 9a, 9b.

Any longitudinal part to which the skin is adhesively bonded is known as a flange.

The bearing plates 5 form ribs of the wing in the junction zone between the sections.

The beams 9 are fixed to the ribs 5 by adhesive bonding or by splice plates such as L-shaped tabs.

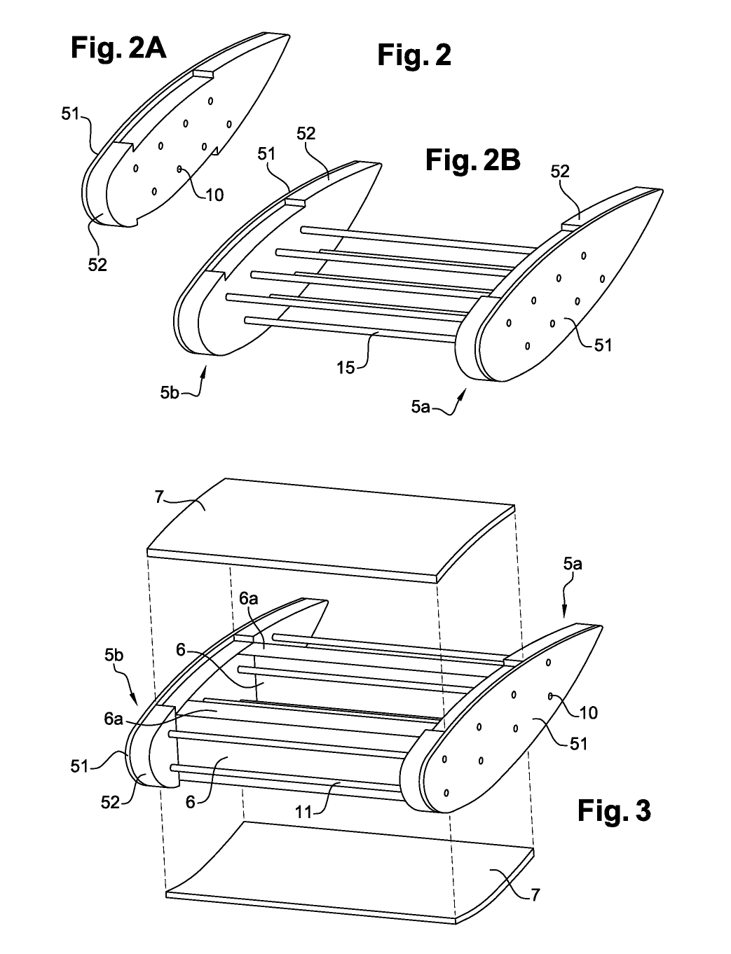

According to FIG. 2A, the bearing plates are produced by assembling rigid external plates 51 with closing blocks 52 of the tubular connecting boxes.

The blocks closely match the profile of the external plates in order that the assembly of external plates and blocks forms ribs of the wing sections 1a, 1b.

The bearing plates are provided with through-holes 10 for clamping rods.

The holes may be produced in the external plates and the separate closing blocks.

According to FIG. 2B, tubes 15 for receiving the clamping rods are disposed between the bearing plates.

The tubes 15 for guiding and positioning the rods 3 may be non-structural and produced for example from PVC.

The holes produced in the rigid external plates 51 are smaller than the outside diameter of the tubes, while the holes produced in the blocks 52 have a diameter which is sufficient to allow the tubes 15 to pass through, such that an assembly is attained which is sufficiently strong for handling the assembly of bearing plates and tubes.

The external plates are metal, for example made of steel. There may be four of said external plates, which are positioned on either side of each of the two central joining box structures. The two blade sections to be assembled are in contact in the region of metal end plates that terminate the box structures and the sections.

According to the example in FIGS. 6B and 6D, the two external plates located in the region of the connection between the sections are specific: one 510a has at least two centering pins while the other 510b has at least two drilled holes, in which the pins of the first end plate are housed.

According to the example in FIGS. 6A and 6C, the exterior external plates 51 are flat.

In order to avoid making the connection statically indeterminate, the drilled holes intended for the rods are dimensioned so as to allow a certain amount of positioning play for the rods.

The closing blocks 52 of the connecting boxes are advantageously made of PVC, PS or PU foam or of balsa wood and have the shape of the aerodynamic profile of the blade. They may either be in one piece, or separated into three parts: leading edge, central box structure and trailing edge, as shown in FIG. 7.

These closing blocks have a number of functions: they act as adhesive-bonding areas during the closure of the lower surface onto the upper surface, form housings for positioning the guide tubes 15 of the tie rods and close the connecting boxes, as will be seen below.

FIG. 3 shows the production of the connecting boxes.

The connecting boxes 4 have spars 6 and cross-beams 7 that are all adhesively bonded to the closing blocks 52 of the connecting boxes.

The method for producing the connecting boxes 4 comprises a step of adhesively bonding spars 6 of the boxes onto closing blocks of the boxes between first and second bearing plates 5a, 5b forming ribs of the wing, and of adhesively bonding cross-beams 7 forming flanges of the box structures.

The spars 6 of the connecting boxes of the central box structures are composite spars, for example sandwich panels, the role of which is to react shear forces.

According to the example, the spars 6, which have projections 6a, are first of all adhesively bonded to the internal faces of the blocks 52 and then the cross-beams are adhesively bonded to the projections 6a of the spars and to the upper and lower edges of the blocks 52.

The adhesive bonding of the spars may be realized by draping L-shaped composite.

The core of the sandwich panels for producing the spars 6 is a PVC, polystyrene or polyurethane foam or balsa wood having a thickness of less than 30 mm, if possible. The skins of these sandwich panels are biaxial glass fiber or biaxial carbon fiber fabrics, the thickness of a skin being less than 2 mm. The spars of the box structures are engineered both statically and for stability.

The cross-beams 7 of the boxes 4 are flange elements of the central box structures and are preferably monolithic panels.

They are glass fibers or carbon fibers that are very predominantly oriented at 0°, that is to say along the longitudinal axis of the wing or of the blade. These flanges react the compressive forces brought about by the clamping of the rods 3. The flanges of the box structures are thus engineered statically, for stability, and for plastic deformation against the metal end plates.

The box structures having the bearing plates 5a, 5b, which are formed by the blocks 52 and the external plates 51, and the boxes 4 may be prefabricated separately in a tool shop and assembled by means of the clamping rods. The skins of the blade are subsequently adhesively bonded to the box structures by way of an epoxy adhesive.

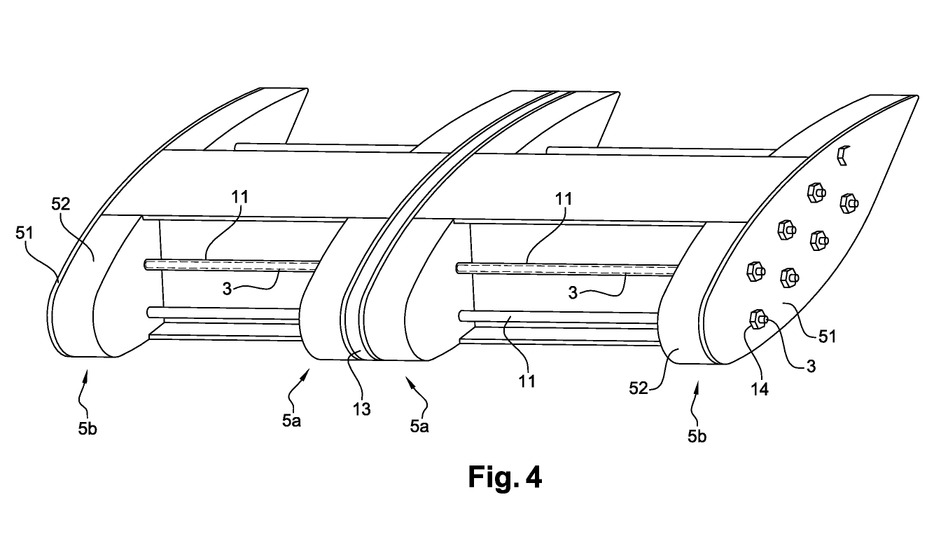

According to FIG. 4, the method for producing the sections comprises a step of placing connecting devices formed by the central joining box structures that are produced by the external plates 51, the closing blocks 52 and the spars 6 and cross-beams 7 of the connecting boxes 4 end-to-end.

In order to assemble the box structures next to one another, the first bearing plates 5a, adjacent plates at the end of the sections, are pressed against a central packing piece 13, and then the rods 3 are inserted and the box structures are placed under compression by the clamping means 14 at the ends of the rods 3.

Some of the clamping rods pass through the connecting boxes 4, while others are outside the connecting boxes.

Since the bearing plates 5a, 5b are provided with through-holes 10 for the clamping rods 3, the latter project from each side of the assembly in order to arrange the clamping means 14.

The rods 3 form an array of tie rods, the clamping of these tie rods to the bearing plates 5b outside the assembly placing the connecting boxes 4 under compression.

The rods 3 forming the tie rods may be made of metal or of composite materials. The number and position of the tie rods are not set, but it may be considered that a correct rigidity of the connection is obtained with four tie rods inside the boxes and four tie rods outside the boxes, two on the leading edge side and two on the trailing edge side.

In the case of metal tie rods, these are threaded metal rods onto which clamping nuts 14 are screwed, as shown.

In the case of composite tie rods, these may be tubes made of glass epoxy or carbon epoxy with a majority of the fibers oriented at 0° in order to react the tensile and bending forces. These composite tubes may be manufactured by way of an extrusion method for economic reasons. Threaded metal inserts are fixed to the ends of the composite tubes in order to be able to clamp the tie rods by way of nuts.

The clamping force applied is determined so as to ensure that the two blade sections do not unstick, but also that the metal or composite tie rods do not yield (or do not tear).

The tie rods bear against the external plates forming end plates that close the box structures in the longitudinal direction of the sections.

As seen above, the external plates 51 are preferably made of metal in order to withstand the compressive forces of the tie rods.

Thus, the production of the wing comprises a step of producing devices for connecting said sections in the form of central box structures 2a, 2b, each of the box structures being provided with a tubular connecting box 4 and bearing plates 5a, 5b, between which the tubular connecting box is received, followed by assembly of these box structures that are connected by a packing piece 13, and clamping of the rods 3.

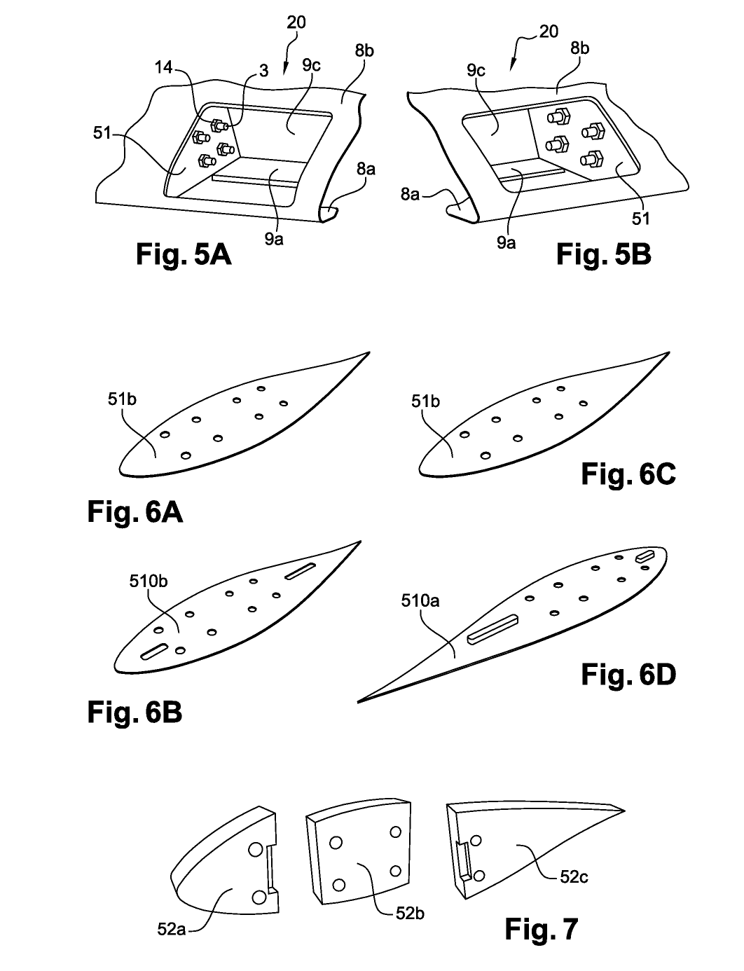

FIGS. 5A and 5B show access holes under open hatches in the sandwich panels of the blade, these making it possible to access the nuts for clamping, for removing the rods after the sections have been manufactured, reinserting the rods in order to assemble the blades at the electricity production site during the installation of the wind turbine and possibly removing the blades for repairs.

The removal of the rods following polymerization of the sections is done by means of the access holes under the hatches in the skin of the wing. The hatches 20 are sandwich panels fixed to the aerodynamic profile of the blade via inserts. They are produced in the lower surface or upper surface and are visible in FIG. 1.

FIGS. 5A and 5B make it possible to see the rods 3 and the nuts 14, the rib 51, the flange 9a and the spar 9c of the beam of the section.

Returning to FIG. 1, once the box structures have been assembled to produce the device for connecting the sections, the sections are constructed on this device.

According to the example, the sections have at least one I-beam 9 extending the box structures 2a, 2b of the connecting device.

Further configurations are possible for the beam 9 in the scope of the aspects of the disclosed embodiment, and in particular it is possible to use two beams or one beam in the form of a tubular spar known as a “spar box”.

In order to produce the sections, the skins 8a, 8b of the lower surface and upper surface of the sections of the wing are adhesively bonded to the flanges of the beam 9, to the ribs 5a, 5b and to the flanges of the box structures formed by the cross-beams 7.

The method for producing the wings comprises a step of adhesively bonding a first skin 8a, forming a first of the lower surface or upper surface of the section of the wing, to the connecting device and of adhesively bonding the first skin to a flange 9a assembled with a spar 9c of the beam 9, and then a step of adhesively bonding a second skin 8b, forming the second of the lower surface or upper surface of the section of the wing, to the connecting device, to the first skin and to a second flange 9b adhesively bonded to the spar 9c, the flanges 9a, 9b and the spar 9c forming a beam element of the wing. Once the wing has been assembled, the method comprises a step of polymerizing the wing in a mold.

Once the wing has been polymerized, the rods 3 are removed and the sections are separated by cutting the packing piece 13 between the first bearing plates 5a.

This makes it possible to store and transport the separated sections to the installation site of the wind turbine.

The assembly of the wing sections at the installation site of the wind turbine comprises a step of placing sections end-to-end in the region of the connecting devices, inserting clamping rods into the ribs of the connecting devices and clamping the rods by nuts at the ends of the rods.

The complete blade is then mounted on the wind turbine.

The aspect of the disclosed embodiment shown applies more particularly to wind turbine blades, but the disclosed embodiment applies to any device for connecting sections by way of box structures and tie rods, whether these be wind turbine blades, aircraft wings or any structure made of sections.

1. A device for connecting sections of wings such as wind turbine blades, comprising: at the ends of each adjacent section, box structures that are placed end-to-end and are clamped together by clamping rods, said box structures having, for each section, a tubular connecting box received between two bearing plates, said bearing plates forming ribs of the section.

2. The connecting device as claimed in claim 1, wherein the clamping rods pass through the connecting boxes and the bearing plates.

3. The connecting device as claimed in claim 1, wherein the rods form an array of tie rods, the clamping of these tie rods to the bearing plates putting the connecting boxes under compression.

4. The connecting device as claimed in claim 1, wherein the bearing plates are shaped as ribs of the wing sections.

5. The connecting device as claimed in claim 1, wherein the box structures form spacers of the sections.

6. The connecting device as claimed in claim 1, wherein the tubular connecting boxes have spars and cross beams that are all adhesively bonded to closing blocks of the connecting boxes, said blocks forming, together with rigid external plates, said bearing plates.

7. The connecting device as claimed in claim 6, wherein the spars are composite spars.

8. The connecting device as claimed in claim 6, wherein the cross-beams of the box structures are flange elements of the sections.

9. A wing, such as a wind turbine blade, made of a number of sections, comprising: at least one connecting device as claimed in claim 1.

10. A wing, such as a wind turbine blade, made of a plurality of sections, having at least one connecting device as claimed in claim 8, wherein the skins of the lower surface and upper surface of the sections of the wing are adhesively bonded to the flanges of the sections.

11. The wing as claimed in claim 9, wherein the sections have at least one I-beam extending the box structures of the connecting device.

12. A method for producing sections of wings such as wind turbine blades, comprising: for each section, a step of producing a device for connecting said sections in the form of a central joining box structure from a tubular connecting box and bearing plates, between which the tubular connecting box is received.

13. The method for producing wing sections as claimed in claim 12, further comprising: a step of drilling through-holes for clamping rods in the bearing plates and a step of positioning tubes for receiving the clamping rods between the bearing plates.

14. The method for producing sections of wings such as wind turbine blades as claimed in claim 12, further comprising: a step of adhesively bonding spars of the connecting boxes to closing blocks of the boxes and of adhesively bonding cross-beams that form flanges of the box structures.

15. The method for producing wing sections as claimed in claim 14, further comprising: a step of placing the connecting devices end-to-end, the first bearing plates being pressed against a central packing piece, a step of inserting the rods and of putting the box structures under compression by way of clamping means at the ends of the rods.

16. The method for producing wing sections as claimed in claim 14, wherein the bearing plates are produced by assembling rigid external plates with the closing blocks of the boxes.

17. The method for producing wing sections as claimed in claim 12, further comprising: a step of adhesively bonding a first skin, forming a first of the lower surface or upper surface of the section of the wing, to the connecting device and of adhesively bonding the first skin to a first flange assembled with a spar of a beam, and a step of adhesively bonding a second skin, forming the second of the lower surface or upper surface of the section of the wing, to the connecting device, to the first skin and to a second flange adhesively bonded to the spar, the first and second flanges and the spar forming a beam element of the wing.

18. The method for producing wing sections as claimed in claim 17, further comprising: a step of polymerizing the wing in a mold.

19. The method for producing wing sections as claimed in claim 18, further comprising: a final step of removing the rods and separating the sections by cutting the packing piece between the first bearing plates in order to store and transport the separated sections.

20. A method for assembling wing sections produced by the method in claim 13, comprising: a step of placing the sections end-to-end in the region of the connecting devices, inserting clamping rods into the bearing plates of the connecting devices and clamping the rods by way of nuts at the ends of the rods.
